(19) United States
(12) Patent Application Publication
(10) Pub. No.: US 2010/0070906 A1
(43) Pub. Date: Mar. 18, 2010

(54) MAINTENANCE COMPUTER AND COMPUTER PROGRAM PRODUCT FOR A MAINTENANCE COMPUTER

(75) Inventor: Ryoji HISHIKAWA, Kakogawa-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/538,491

(22) Filed: Aug. 10, 2009

(30) Foreign Application Priority Data
Sep. 18, 2008 (JP) 2008-239579

(51) Int. Cl. G06F 3/048; G05D 7/06

(52) U.S. Cl. 715/772; 700/282

(57) ABSTRACT

A maintenance computer used for a maintenance operation of a sample processing apparatus comprising a plurality of fluid sections for processing a sample, and plurality of devices for controlling a flow of a sample by the fluid sections is disclosed.

A computer program product for a maintenance computer is also disclosed.

### FIELD OF THE INVENTION

The present invention relates to a maintenance computer and computer program product used to maintain a sample processing apparatus such as a blood analyzer, urine analyzer and the like.

### BACKGROUND

In recent years, the structures of clinical sample processing apparatuses such as blood analyzers and urine analyzers have become increasingly complex as analysis items have been added, additional elements expanded, and the apparatus made more compact. Therefore, repair and maintenance operations must be performed with unerring accuracy by a highly skilled technician who visits the installation site.

For example, Laid-Open U.S. Patent 2006-0210438 discloses a conventional blood analyzer. A clinical sample analyzer typified by a blood analyzer is configured by many components and a plurality of pipes to transport sample and reagent and the like to each mechanism in a complexity of connections and layout as can be clearly observed from the flow paths within the casing shown in the drawings disclosed in Laid-Open U.S. Patent 2006-0210438.

A clinical sample analyzer which has complex plumbing and wiring, such as that disclosed in Laid-Open U.S. Patent 2006-0210438, requires man-hours for repair and maintenance operations equivalent to the complexity of the configuration. For example, when a predetermined mechanism within the apparatus breaks down, the plumbing and wiring connected to the mechanism must be removed to replace components and then re-connected. Such operations require that the technician verifies the actual plumbing and wiring while referencing plumbing and wiring diagrams as he accurately removes and re-connects the plumbing and wiring.

However, a clinical sample analyzer which has been installed in a facility cannot be removed therefrom for repair, so that the repair and maintenance operations must of necessity be performed on site. When a plurality of examination devices are installed in a laboratory center or the laboratory of a hospital, however, there is limited space available for the repair and maintenance operations. It is therefore difficult to ensure that adequate space is available to spread out large plumbing and wiring diagrams, thus causing a problem insofar as it is difficult to perform the repair and maintenance operations while referring to the diagrams.

There is currently a strong demand for increasingly fast examinations in conjunction with the desire for early diagnosis of disease and, therefore, the apparatus downtime for repair and maintenance operations must be limited as much as possible for apparatuses, such as clinical sample analyzers, which are used in these examinations. There is therefore also a problem related to such time limitations when performing repair and maintenance operations while referring to plumbing and wiring diagrams.

### SUMMARY OF THE INVENTION

A first aspect of the invention is a maintenance computer used for a maintenance operation of a sample processing apparatus comprising a plurality of fluid sections for processing a sample, and plurality of devices for controlling a flow of a sample by the fluid sections, the maintenance computer comprising: a display; and a controller including a memory under control of a processor, wherein the memory stores: plumbing data related to plumbing connecting the fluid sections, and wiring data related to wiring electrically connecting the devices; and/or a series of plumbing data sets containing a plurality of continuously linked plumbing data, and a series of wiring data sets containing a plurality of continuously linked wiring data; and instructions enabling the processor to carry out operations, comprising: displaying, on the display, the plumbing data and wiring data stored in the memory, and/or the series of plumbing data sets and series of wiring data sets stored in the memory; and switching, in accordance with a reception of an instruction signal generated by an operation of a pointing device, a display format of the plumbing data or wiring data corresponding to the instruction signal, or a series of plumbing data sets or series of wiring data sets corresponding to the instruction signal to another display format.

A second aspect of the invention is a maintenance computer used for a maintenance operation of a sample processing apparatus comprising a plurality of fluid sections for processing a sample, and plurality of devices for controlling a flow of a sample by the fluid sections, the maintenance computer comprising: a memory for storing: plumbing data related to plumbing connecting the fluid sections, and wiring data related to wiring electrically connecting the devices; and/or a series of plumbing data sets comprising a plurality of continuously linked plumbing data, and a series of wiring data sets comprising a plurality of continuously linked wiring data; a display for displaying the plumbing data and wiring data stored in the memory, and/or the series of plumbing data sets and series of wiring data sets stored in the memory; and a display switcher for switching, in accordance with a reception of an instruction signal generated by an operation of a pointing device, a display format of the plumbing data or wiring data corresponding to the instruction signal, or a series of plumbing data sets or series of wiring data sets corresponding to the instruction signal to another display format.

A third aspect of the invention is a computer program product for a maintenance computer used for a maintenance operation of a sample processing apparatus comprising a plurality of fluid sections for processing a sample, and plurality of devices for controlling a flow of a sample by the fluid sections; a computer readable medium for storing: plumbing data related to plumbing for connecting the fluid sections, wiring data related to the wiring electrically connecting the devices, and/or a series of plumbing data sets comprising a plurality of continuously linked plumbing data and a series of wiring data sets comprising a plurality of continuously linked wiring data; and instructions adapted to enable a general purpose computer to carry out operations, comprising: displaying the plumbing data and wiring data, and/or the series of plumbing data sets and series of wiring data sets; and switching, in accordance with a reception of an instruction signal generated by an operation of a pointing device, a display format of the plumbing data or wiring data corresponding to a received instruction signal, or a series of plumbing data sets or series of wiring data sets corresponding to the instruction data to another display format.

### BRIEF DESCRIPTION OF THE DRAWINGS

FIG. 1 is a block diagram showing the hardware structure when the maintenance terminal device of an embodiment of the present invention is realized using a CPU;

FIG. 2 is a function block diagram of the maintenance terminal device of the embodiment of the present invention;

FIG. 4 shows examples of the displayed plumbing data and wiring data;

FIG. 5 is a function block diagram of the maintenance terminal device of the embodiment of the present invention when the plumbing data and wiring data are displayed;

FIG. 6 is a flowchart showing the sequence of the processing by the CPU of the maintenance terminal device of the embodiment of the present invention;

FIG. 7 shows an example when the display format has been switched for a series of plumbing data sets or series of wiring data sets containing the specified plumbing data or wiring data;

FIG. 8 is a flowchart showing the sequence of the detail information display process by the CPU of the maintenance terminal device of the embodiment of the present invention;

FIG. 9 shows an example of an enlarged diagram of the detail information at the terminus;

FIG. 10 shows an example of the detail information display when the endpoint of a selected series of plumbing data sets is a chamber;

FIG. 11 shows an example of the detail information display when the endpoint of a selected series of wiring data sets is a valve; and

FIG. 12 shows an example of window switching.

### DETAILED DESCRIPTION OF THE PREFERRED EMBODIMENTS

Hereinafter, embodiments of a sample analyzer of the invention will be described in detail with reference to the accompanying drawings.

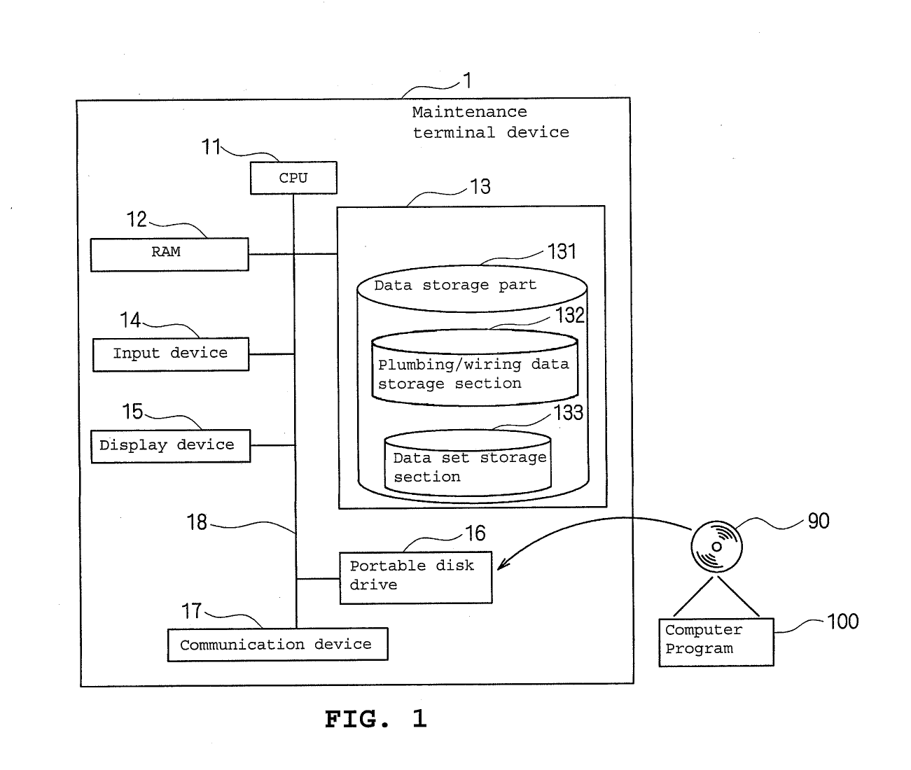

An embodiment of the maintenance terminal device of the present invention is described in detail below based on the drawings. FIG. 1 is a block diagram showing the hardware structure when the maintenance terminal device of an embodiment of the present invention is realized using a CPU.

As shown in FIG. 1, the maintenance terminal device 1 of the present embodiment is configured by a CPU (central processing unit) 11, RAM 12, memory device 13, input device 14, display device 15, portable disk drive 16, communication device 17, and an internal bus 18 which connects the aforesaid hardware. Connected to each hardware component of the maintenance terminal device 1 via the internal bus 18 so as to control the operation of each hardware component, and execute various software functions according to a computer program 100 which is stored in the memory device 13.

The RAM 12 is configured by an SRAM, flash memory or the like, and is used to expand loaded modules when executing the computer program 100, and is used to store temporary data developed when executing the computer program 100. Of course the computer program 100 may also be prestored on the memory device 13.

The memory device 13 is configured by a built-in fixed-type storage device (hard disk), ROM or the like. The computer program 100 stored on the memory device 13 is downloaded to the portable disk drive 16 from a DVD, CD-ROM or the like which stores the program and data, and is expanded from the memory device 13 to the RAM 12 during execution. Of course, the computer program may also be downloaded from an external computer via the communication device 17.

The memory device 13 is provided with a data storage part 131 for storing data related to plumbing and/or wiring. The data storage part 131 is provided with a plumbing/wiring data storage section 132 for storing plumbing data and wiring data, and/or a data set storage section 133 for storing a consecutively linked plurality of plumbing data or plurality of wiring data as a series of plumbing data sets or series of wiring data sets. The plumbing data and wiring data stored in the plumbing/wiring data storage section 132 may be vector data such as CAD data, or may be raster data such as image data. If the absolute coordinates of the screen center and the relative coordinates therefrom are stored in memory, the data format does not matter since the position indicated by a pointer on the screen can be calculated when displayed on the screen.

The series of plumbing data sets or series of wiring data sets are associated with the position in formation of the plumbing data or wiring data and stored in the data set storage section 133. The series of plumbing data sets or series wiring data sets may be displayed singly or may be displayed by overlapping the plumbing data and wiring data stored in the plumbing/wiring data storage section 132. Similarly, the plumbing data and wiring data alone may be displayed singly. When the plumbing data and wiring data stored in the plumbing/wiring data storage section 132 are CAD data, the data may also be stored separately as multilevel data.

The communication device 17 is connected to the internal bus 18, and is capable of sending and receiving data to/from an external computer or the like when connected to an external network such as the Internet, a LAN, WAN or the like. That is, the memory device 13 is not limited to the configuration of being built into the maintenance terminal device 1 inasmuch as it may also be an external memory medium such as an external storage or the like connected through the communication device 17.

The input device 14 is a data input medium such as a keyboard and mouse or the like. The display device 15 is a display device such as a CRT monitor, LCD or the like.

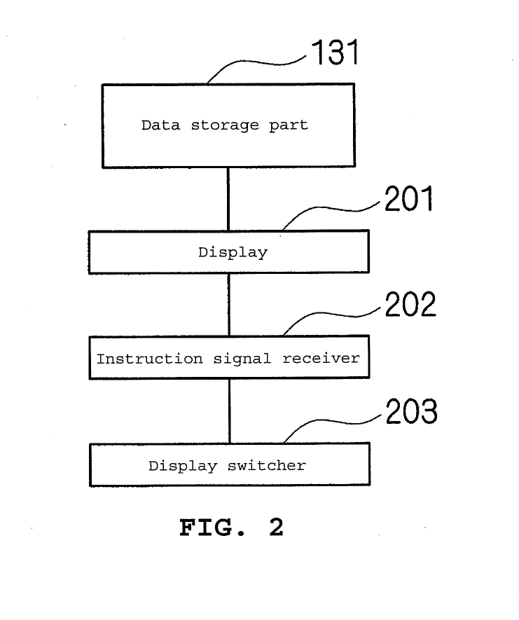

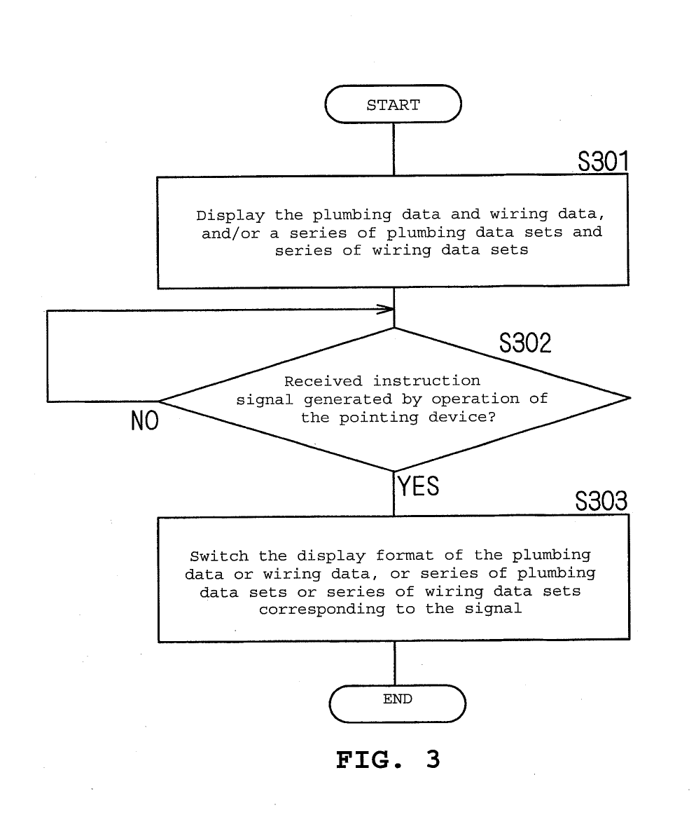

FIG. 2 is a function block diagram of the maintenance terminal device 1 of the embodiment of the present invention. The maintenance terminal device 1 of the present embodiment shown in FIG. 2 has, in the memory device 13, a data storage section 131 for associating and storing the plumbing data related to the plumbing connecting a plurality of fluid sections incorporated in the sample processing device, and wiring data related to the control wires for controlling the operation of the plurality of devices incorporated in the sample processing device, and/or a plurality of continuously linked plumbing data or plurality of continuously linked wiring data, with the position information of the plumbing data or wiring data as a series of plumbing data sets or series of wiring data sets.

A display 201 displays the stored plumbing data or wiring data, and/or the series of plumbing data sets or series of wiring data sets. That is, the plumbing data and wiring data may be displayed, a series of plumbing data sets or series of wiring data sets alone may be displayed, or both plumbing data and wiring data together with a series of plumbing data sets or series of wiring data sets may be superimposed and displayed.

An instruction signal receiver 202 for receiving an instruction signal by the operation of a pointing device such as a mouse or the like, and a display switcher 203 for switching the display format of a specified plumbing data or wiring data, or a series of plumbing data sets or wiring data sets to another display format when an instruction signal produced by the operation of a mouse or the like has been received. For example, when only the plumbing data or wiring data are being displayed in an initial display, the display mode of only the plumbing data or wiring data of the received instruction is switched. Similarly, when only a series of plumbing data sets or series of wiring data sets are being displayed, the display mode of only the series of plumbing data sets or series of wiring data sets of the received instruction is switched.

The display of the plumbing data or wiring data on the initial screen may also be switched so that a series of plumbing data sets or series of wiring data sets are displayed in [black], and only a series of plumbing data sets or series of wiring data sets for which an instruction signal has been received are displayed in [red]. In this way the display format can be switched for only the series of plumbing data sets or wiring data sets corresponding to the plumbing data or wiring data for which the instruction signal has been received in order to display a mixture of the plumbing data and wiring data when it is difficult to determine which tubing is connected to which wiring, thereby making it easy to determine the connection of each specified tubing or wiring.

The reception of the instruction signal generated by operation of the pointing device may be a reception of the position information of the pointer such as a mouse, or may be reception of a selection made by clicking the mouse. That is, the display format may be switched just by moving the mouse pointer, or the display format may be switched by clicking the mouse.

The sequence of the processing performed by the maintenance terminal device 1 of the above configuration is described below. FIG. 3 is a flowchart showing the sequence of the processing of the CPU 11 of the maintenance terminal device 1 of the embodiment of the present invention.

In FIG. 3, the CPU 11 of the maintenance terminal device 1 reads the plumbing data and wiring data and/or a series of plumbing data sets and series of wiring data sets from the data storage part 131 of the memory device 13, and displays the data (step S301).

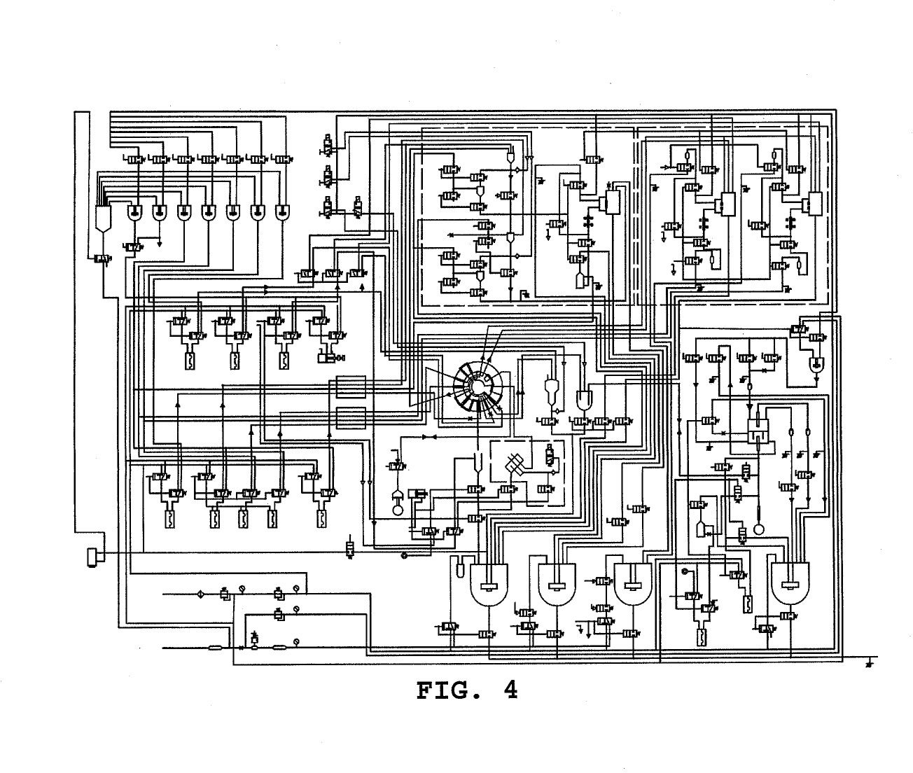

FIG. 4 shows examples of the displayed plumbing data and wiring data. As shown in FIG. 4, the plumbing data and wiring data are displayed without specific differentiation. It is therefore difficult even for a skilled technician to promptly comprehend which tubing and which wiring are connected.

In FIG. 4, only the series of plumbing data sets and series of wiring data sets may be displayed with the same type wires displayed in the same color. The operator is not aware whether only plumbing data and wiring data are displayed, or whether only a series of plumbing data sets and series of wiring data sets are displayed, or whether both are displayed. Of course, when the plumbing data and wiring data are CAD data, the series of plumbing data sets and series of wiring data sets are set at each level so that all levels may be displayed simultaneously.

Returning to FIG. 3, the CPU 11 of the maintenance terminal device 1 determines whether an instruction signal has been received from the pointing device such as a mouse or the like (step S302). When the CPU 11 has determined that an instruction signal has not been received (step S302: NO), the CPU 11 enters the instruction signal reception standby state.

When the CPU 11 determines that an instruction signal has been received (step S302: YES), the CPU 11 switches the display format of the plumbing data or wiring data corresponding to the instruction signal, or the series of plumbing data sets or series of wiring data sets to another display format (step S303). For example, the display of plumbing data or wiring data, or a series of plumbing data sets or series of wiring data sets which are displayed in [black] can be switched so that only the plumbing data or wiring data, or the series of plumbing data sets or series of wiring data sets corresponding to the instruction signal are displayed in [red].

In this way switching the display format for only the specified plumbing data or wiring data, or series of plumbing data sets or wiring data sets makes it easy to determine the connection of each specified tubing or wiring by displaying a mixture of the plumbing data and wiring data when it is difficult to determine the connection of the tubing or wiring.

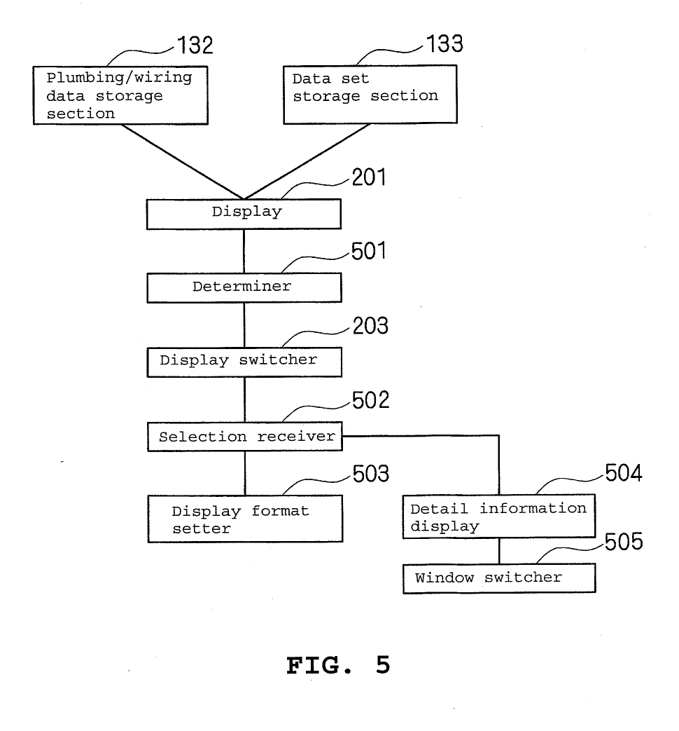

It is actually desirable that the plumbing data or wiring data, and the corresponding series of plumbing data sets or series of wiring data sets are displayed simultaneously. This is because the plumbing data or wiring data, and corresponding series of plumbing data sets or series of wiring data sets display format does not matter. FIG. 5 is a function block diagram of the maintenance terminal device 1 of the embodiment of the present invention when both data are displayed. The maintenance terminal device 1 of the present embodiment shown in FIG. 5 has, in the memory device 13, a plumbing/wiring data storage section 132 for storing plumbing data related to the plumbing connecting the fluid parts and the wiring data related to the control wires for controlling the operation of the components, and a data set storage section 133 for associating the plurality of continuously linked plumbing data or plurality of continuously linked wiring data with the position information of the plumbing data or wiring data and storing the data as a series of plumbing data sets or series of wiring data sets.

The display 201 displays the stored plumbing data and wiring data. In the present embodiment, the plumbing data and wiring data stored in the plumbing/wiring data storage section 132 may be displayed superimposed on the series of plumbing data sets or series of wiring data sets stored in the data set storage section 133.

A determiner 501 determines whether a position specified by a pointing device, that is, a position of the mouse pointer or the like, is a position within a predetermined range of the display position of the plumbing data or wiring data. In this way it can be determined which plumbing data or wiring data a mouse pointer or the like is specifying among the plumbing data or wiring data.

A display switcher 203 switches the display format of the series of plumbing data sets or series of wiring data sets containing the specified plumbing data or wiring data to another display format when the determiner 501 has determined that the mouse pointer is positioned within the predetermined range. For example, the display of the plumbing data or wiring data, and series of plumbing data sets or series of wiring data sets displayed in [black] on the initial display can be switched so that only the series of plumbing data sets or series of wiring data sets containing the specified plumbing data or wiring data are displayed in [red]. In this way switching the display format for only the series of plumbing data sets or series of wiring data sets containing the specified plumbing data or wiring data makes it easy to determine the connection of the specified plumbing or wiring by displaying a mixture of the plumbing data and wiring data when it is difficult to determine which tubing is connected to which wiring.

A selection receiver 502 receives the selection of the series of plumbing data sets or series of wiring data sets containing the specified plumbing data or wiring data when the determiner 501 has determined that the mouse pointer is positioned within the predetermined range. Specifically, the selection is received when the operator clicks the mouse while the mouse pointer is specifying the plumbing data or wiring data.

A display format setter 503 sets and locks the display format of the selected series of plumbing data sets or series of wiring data sets to the display format at the time the selection was received when the selection receiver 502 has received a selection. The connection relationship can thus be reliably verified without changing the display format of subsequent series of plumbing data sets or series of wiring data sets even when the mouse pointer has been moved to track the plumbing and wiring.

A detail information display 504 displays detail information related to the connection of the terminus of the selected series of plumbing data sets or series of wiring data sets when the selection receiver 502 has received a selection. Specifically, the state of the connection at the terminus of the series of plumbing data sets or series of wiring data sets is displayed when the mouse pointer is specifying plumbing data or wiring data and the operator clicks the mouse and the selection is received. The detail information related to which device the plumbing is connected to or the terminal of which device the wiring is connected to can thus be verified to prevent plumbing errors and wiring errors before they occur when removing and reconnecting the plumbing and wiring.

A window switcher 505 switches the display content from one window to another window when plumbing data or wiring data are displayed in one window and detail information representing the state of the connection of the terminus of a selected series of plumbing data sets or series of wiring data sets is displayed in another window. The trigger for switching the display content is not particularly limited, and may be accomplished by clicking the mouse on the other window, or switching at the moment the mouse pointer enters the display region of the other window.

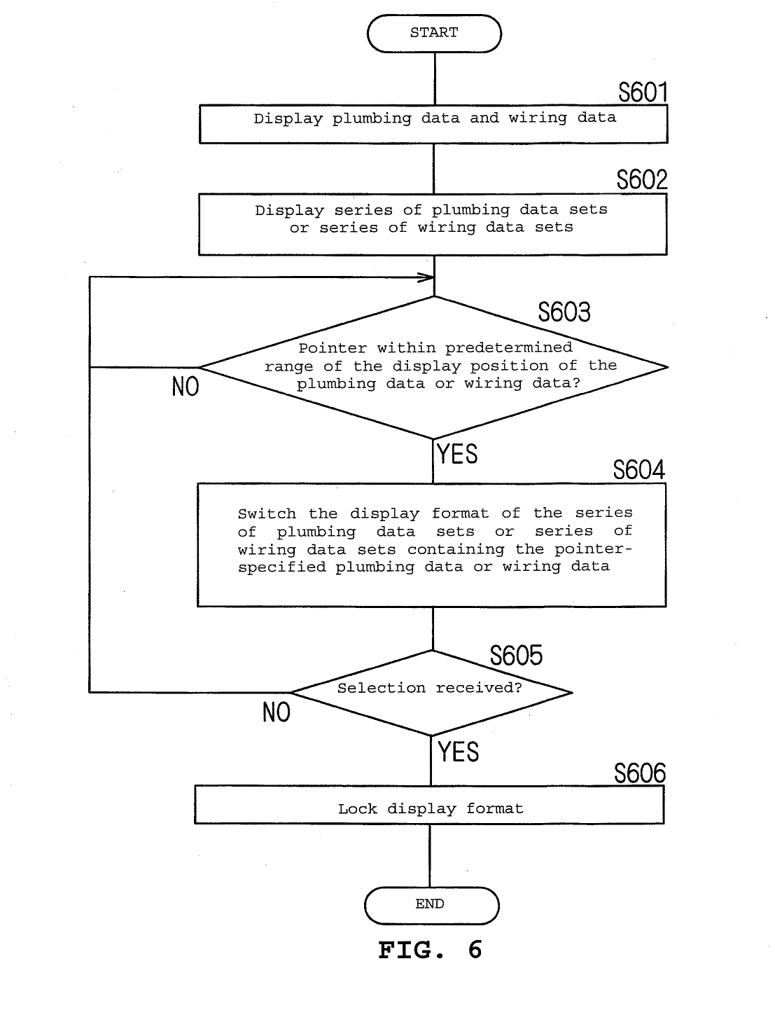

The sequence of the processing performed by the maintenance terminal device 1 of the above configuration is described below. FIG. 6 is a flowchart showing the sequence of the processing of the CPU 11 of the maintenance terminal device 1 of the embodiment of the present invention.

In FIG. 6, the CPU 11 of the maintenance terminal device 1 reads the plumbing data and wiring data from the memory device 13, and displays the data on the display device 15 (step S601). The CPU 11 simultaneously reads the series of plumbing data sets and series of wiring data sets, and displays the data superimposed on the front of the displayed plumbing data and wiring data (step S602).

The CPU 11 determines whether the position of the mouse pointer is positioned within a predetermined range of the display position of the plumbing data or wiring data. When the CPU 11 has determined that the pointer is not positioned within the predetermined range (step S603: NO), the CPU 11 waits until the position of the mouse pointer is within the predetermined position.

When the CPU 11 has determined that the pointer is positioned within the predetermined range (step S603: YES), the CPU 11 switches the display format of the series of plumbing data sets or series of wiring data sets that contain the plumbing data or wiring data specified by the mouse pointer to another display format (step S604). For example, in steps S601 and S602, the display of the plumbing data or wiring data, and series of plumbing data sets or series of wiring data sets displayed in [black] can be switched so that only the series of plumbing data sets or series of wiring data sets containing the specified plumbing data or wiring data are displayed in [red].

According to this configuration, switching the display format for only the series of plumbing data sets or series of wiring data sets containing the specified plumbing data or wiring data makes it easy to determine the connection of the specified plumbing or wiring by displaying a mixture of the plumbing data and wiring data when it is difficult to determine which tubing is connected to which wiring.

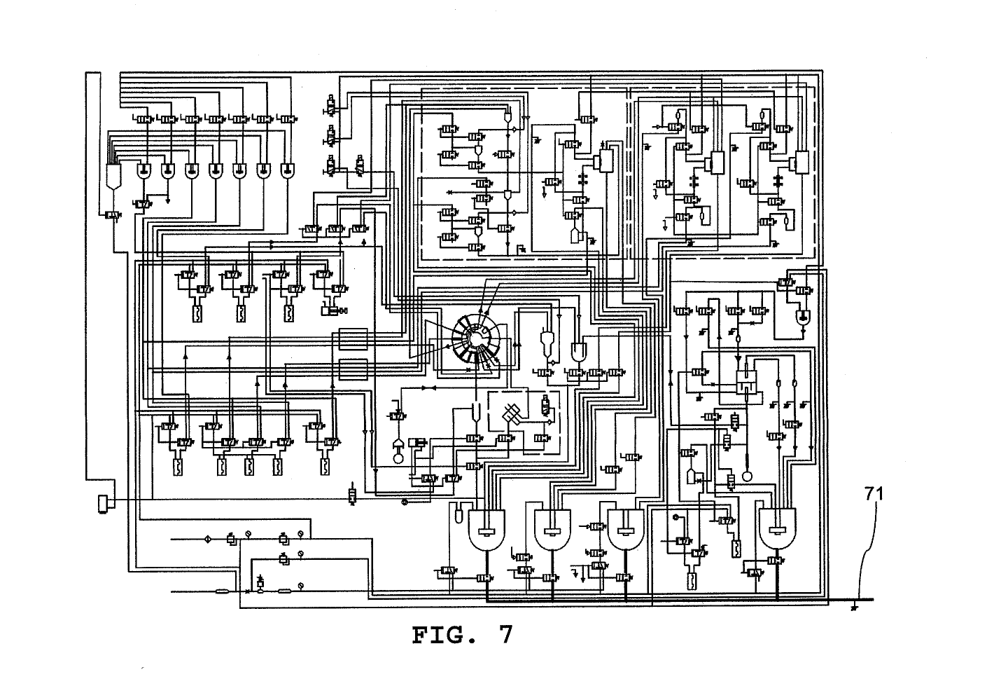

FIG. 7 shows an example when the display format has been switched for a series of plumbing data sets or series of wiring data sets containing the specified plumbing data or wiring data. FIG. 7 shows the tubing 71 indicated by the thick solid line as tubing for which the display format has been switched. It is therefore possible to easily visually verify the series of plumbing data sets or series of wiring data sets by switching the display format even in the case of complex plumbing and wiring.

Returning to FIG. 6, the CPU 11 of the maintenance terminal device 1 determined whether a selection of a series of plumbing data sets or series of wiring data sets containing specified plumbing data or wiring data has been received (step S605). Specifically, the CPU 11 determines whether plumbing data or wiring data corresponding to a mouse click operation has been selected when the mouse pointer is positioned on or near plumbing data or wiring data.

When the CPU 11 has determined that a selection of a series of plumbing data sets or series of wiring data sets containing specified plumbing data or wiring data has not been received (step S605: NO), the CPU 11 returns the process to step S603 and the above-described processes are repeated. When the CPU 11 has determined that a selection of a series of plumbing data sets or series of wiring data sets containing specified plumbing data or wiring data has been received (step S605: YES), the CPU 11 sets and locks the display format of the selected series of plumbing data sets or series of wiring data sets to the display format of the moment the selection was received (step S606).

The connection relationship can thus be reliably verified without changing the display format of subsequent series of plumbing data sets or series of wiring data sets even when the mouse pointer has been moved to track the plumbing and wiring.

On the other hand, the terminus of the series of plumbing data sets or series of wiring data sets for which the display format is being changed, that is, the part connected to another component or device at the end of the series of plumbing data sets or series of wiring data sets, is often unclear as to the actual connector type or how the wire is connected to the terminal or the like. In this case, it is desirable to display detail information related the connection of the terminus of the selected series of plumbing data sets or series of wiring data sets when it has been determined that a selection of a series of plumbing data sets or series of wiring data sets has been received.

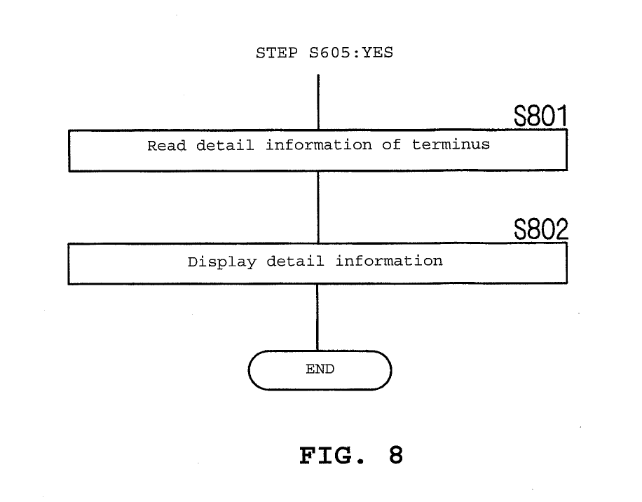

FIG. 8 is a flowchart showing the sequence of the detail information display process of the CPU 11 of the maintenance terminal device 1 of the embodiment of the present invention. As shown in FIG. 8, when the CPU 11 of the maintenance terminal device 1 has determined it has received the selection of the series of plumbing data sets or a series of wiring data sets containing the specified plumbing data or wiring data (step S605: YES), the CPU 11 reads the detail information related to the selected series of plumbing data sets or series of wiring data sets from the memory device 13 (step S801), and sends the read detail information to the display device 13 to be superimposed and displayed on the previously displayed plumbing data and wiring data (step S802).

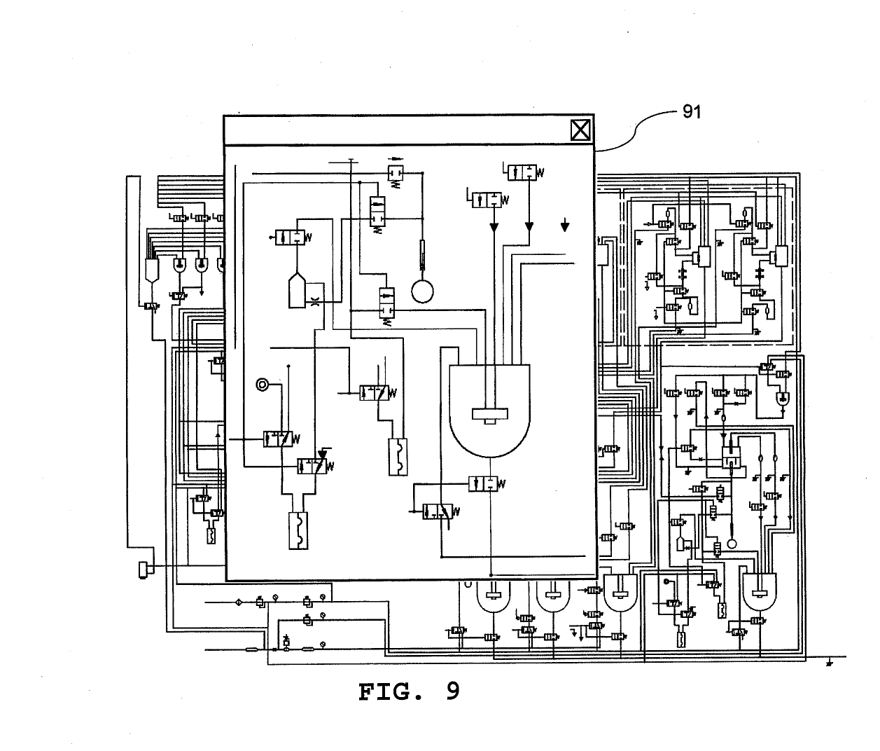

Specifically, the state of the connection at the terminus of the series of plumbing data sets or series of wiring data sets is displayed when the mouse pointer is specifying plumbing data or wiring data and the operator clicks the mouse and the selection is received. FIG. 9 shows an example of an enlarged diagram of the detail information at the terminus. FIG. 9 shows enlarged plumbing data 91 in another window separate from the window displaying the plumbing data or wiring data.

The detail information is not limited to an enlarged diagram of the terminus, and may also be a three-dimensional perspective diagram, photograph or the like.

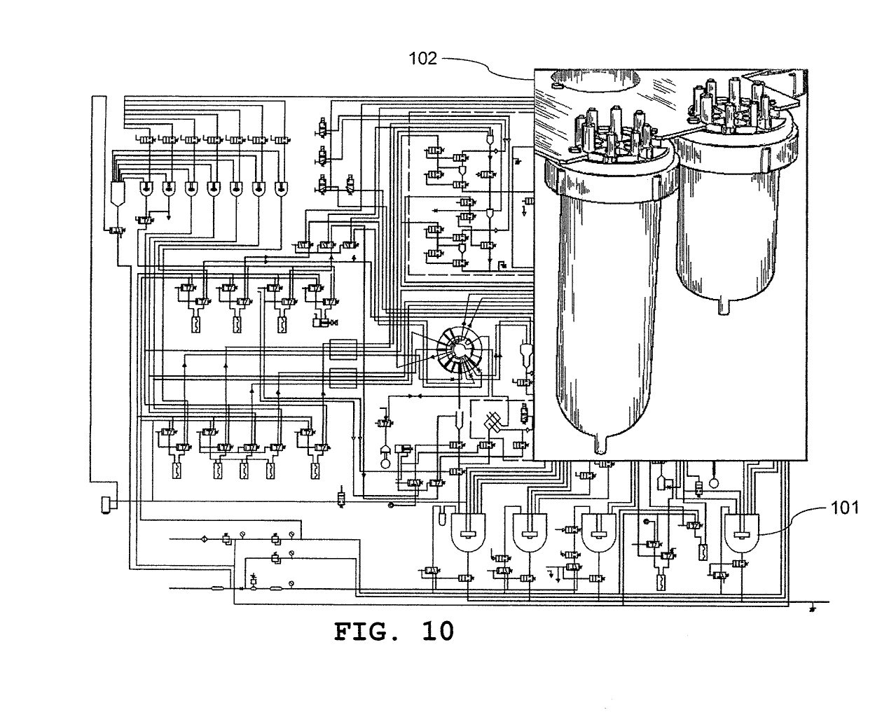

FIG. 10 shows an example of the detail information display when the endpoint of a selected series of plumbing data sets is a chamber.

As shown in FIG. 10, an enlarged perspective diagram 102 of a chamber 101 is displayed in a separate window when the endpoint of the selected series of plumbing data sets is the chamber 101. The location and type of connection of the plumbing can be reliably verified visually by displaying a specific diagram in this way.

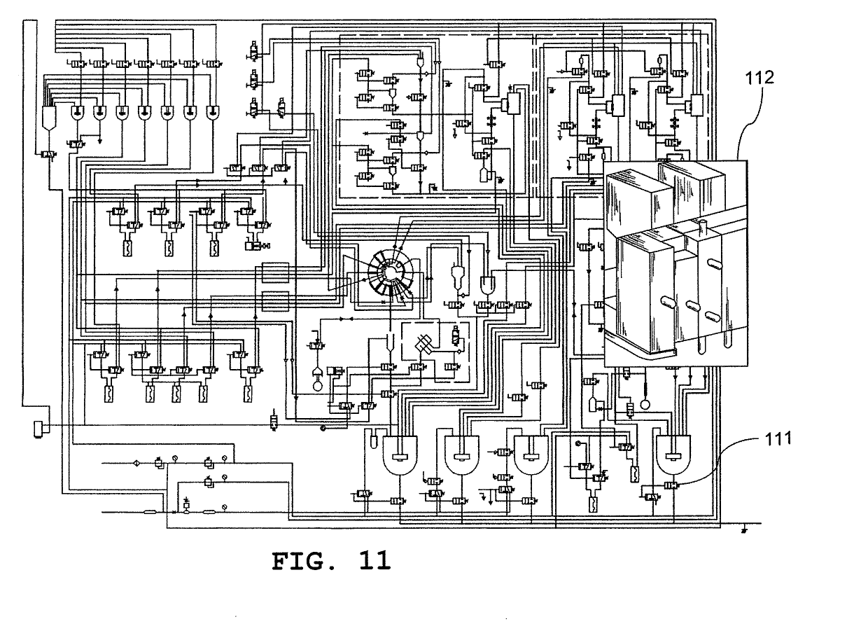

Similarly, FIG. 11 shows an example of the detail information display when the endpoint of a selected series of plumbing data sets is a valve. As shown in FIG. 11, an enlarged perspective diagram 112 of a valve 111 is displayed in a separate window when the endpoint of the selected series of plumbing data sets is the valve 111. The detail information related to which device the plumbing is connected to or the terminal of which device the wiring is connected to can thus be verified to prevent plumbing errors and wiring errors before they occur when removing and reconnecting the plumbing and wiring.

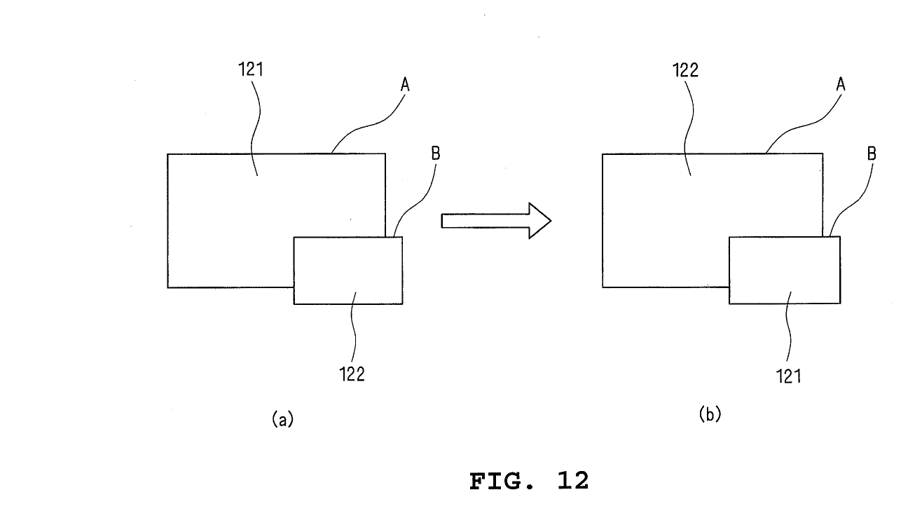

Note that it is desirable to display in a plurality of windows when displaying the detail information, and further desirable to switch the display object between windows. FIG. 12 shows an example of window switching.

FIG. 12(a) shows the plumbing data and wiring data 121 in a main window A, and displays the detail information representing the state of the connection of the terminus of the selected series of plumbing data sets and series of wiring data sets in a sub window B. When the connection work is executed, however, the information related to which component or device to connect the terminus is of greater importance than the information relating to the extension of the plumbing or wiring.

In FIG. 12(b), work efficiency can be increased by switching the displays so that the plumbing data and wiring data 121 are displayed in the sub window B, and the detail information 122 representing the state of the connection of the terminus of the selected series of plumbing data sets or series of wiring data sets is displayed in the main window A.

The trigger for switching the display content of a window is not particularly limited inasmuch as switching may occur when a mouse click operation is performed in the sub window B, or switching may also occur at the moment the mouse pointer enters the sub window B.

According to the present embodiment described above, a series of plumbing and wiring can be easily verified visually to ensure that work is performed accurately while verifying the correctness of a connection without enlarging large plumbing diagrams and wiring diagrams when performing repair work or maintenance work on an apparatus which has complex plumbing and wiring because it is possible to switch the display format of desired plumbing data and wiring data and/or a stored series of plumbing data sets and series of wiring data sets via a mouse operation or the like.

A series of plumbing and wiring can easily be verified visually to ensure that work is performed accurately while verifying the correctness of a connection without enlarging large plumbing diagrams and wiring diagrams when performing repair work or maintenance work on an apparatus which has complex plumbing and wiring by switching, to another display format, the display format of the series of plumbing data sets or series of wiring data sets containing the corresponding plumbing data or wiring data when it has been determined that the mouse pointer is specifying displayed plumbing data or wiring data. The plumbing path or wiring path can be reliably verified without changing the display format of the selected series of plumbing data sets or series of wiring data sets even when the position of the mouse pointer has changed while tracking the plumbing path or wiring path after the selection has been received in contrast to constantly switching the display format due to the changing position of the mouse pointer until the selection has been received.

The detail information related to how and to what a terminus of a series of plumbing data sets is connected, or how and to what the terminus of a series of wiring data sets is connected can be visually verified and plumbing and wiring can be accurately returned to the original condition when it has been removed by displaying the detail information related to the connection of a terminus of a selected series of plumbing data sets or series of wiring data sets.

Note that changing the display format is not limited to the method of changing the display color, inasmuch as, for example, a method of changing the line width or line type of the displayed plumbing data or wiring data may also be used. For example, the line width may be increased for only the series of plumbing data sets or series of wiring data sets specified by the mouse pointer, or the line type may be displayed as dashed line or the like. Conversely, the display format may also be changed for a series of plumbing data sets or series of wiring data sets other than the series of plumbing data sets or series of wiring data sets specified by the mouse pointer. For example, the line width display may be narrowed as a thin line for the series of plumbing data sets or series of wiring data sets other than the series of plumbing data sets or series of wiring data sets specified by the mouse pointer.

The type of detail information is not particularly limited and may also be a video of the photographed work actually being performed rather than still photographs as in the above embodiment. Images may also be displayed to clarify the procedure when the procedure of the operation is specified.

The maintenance terminal device of the present embodiment may also be applied to any sample processing apparatus insofar as it is used to maintain a sample processing apparatus provided with a plurality of devices for controlling the flow of a sample and a plurality of fluid section for processing the sample. For example, the present invention may also be applied to sample analyzers for analyzing a sample, and sample preparing apparatuses for preparing a sample by processing a specimen.

The embodiment described above may be variously modified insofar as such modification is within the scope of the meaning of the present invention. For example, the plumbing data and wiring data may be completely prestored on an external computer such as a server or the like, so as to be obtainable by the maintenance terminal device 1 through a communication means such as a wireless LAN or the like.

What is claimed is:

1. A maintenance computer used for a maintenance operation of a sample processing apparatus comprising a plurality of fluid sections for processing a sample, and plurality of devices for controlling a flow of a sample by the fluid sections, the maintenance computer comprising:
a display; and
a controller including a memory under control of a processor, wherein the memory stores:
plumbing data related to plumbing connecting the fluid sections, and wiring data related to wiring electrically connecting the devices; and/or
a series of plumbing data sets containing a plurality of continuously linked plumbing data, and a series of wiring data sets containing a plurality of continuously linked wiring data; and
instructions enabling the processor to carry out operations, comprising:
displaying, on the display, the plumbing data and wiring data stored in the memory, and/or the series of plumbing data sets and series of wiring data sets stored in the memory; and
switching, in accordance with a reception of an instruction signal generated by an operation of a pointing device, a display format of the plumbing data or wiring data corresponding to the instruction signal, or a series of plumbing data sets or series of wiring data sets corresponding to the instruction signal to another display format.

2. The maintenance computer according to claim 1, wherein the memory stores the plumbing data and wiring data, and series of plumbing data sets and series of wiring data sets associated with position information of the plumbing data and wiring data;
the displaying operation comprises displaying the plumbing data and wiring data stored in the memory;
and wherein, the switching operation comprises switching the display format of the series of plumbing data sets or series of wiring data sets, in which the plumbing data or wiring data corresponding to the instruction signal is contained, to another display format.

3. The maintenance computer according to claim 1, wherein the operations further comprise determining whether a position specified by the pointing device is positioned within a predetermined range of the display position of the plumbing data or wiring data;
and wherein the switching operation is executed when it is determined by the determined operation that the position is within the predetermined range.

4. The maintenance computer according to claim 3, wherein the operations further comprise:
receiving a selection of a series of plumbing data sets or series of wiring data sets containing plumbing data or wiring data corresponding to the specified position when it is determined by the determining operation that the specified position is within the predetermined range; and
setting the display format of the selected series of plumbing data sets or series of wiring data sets, when a selection is received, to the display format of the moment the selection is received.

5. The maintenance computer according to claim 4, wherein the operations further comprise displaying detail information related to a connection of a terminus of the selected series of plumbing data sets or series of wiring data sets when a selection is received.

6. The maintenance computer according to claim 5, wherein the displaying operation of the detail information comprises displaying, on the display, an image representing a state of the connection of the terminus of the selected series of plumbing data sets or series of wiring data sets.

7. The maintenance computer according to claim 6, wherein the displaying operation comprises displaying the plumbing data and wiring data stored in the memory in one window, and displaying an image representing the state of the connection of the terminus of the selected series of plumbing data sets or series of wiring data sets in another window;
and wherein the operations further comprise switching the display content of the one window and the other window.

8. The maintenance computer according to claim 1, wherein the switching operation comprises switching a display color of the plumbing data or wiring data, or series of plumbing data sets or series of wiring data sets to another display color.

9. A maintenance computer used for a maintenance operation of a sample processing apparatus comprising a plurality of fluid sections for processing a sample, and plurality of devices for controlling a flow of a sample by the fluid sections, the maintenance computer comprising:
a memory for storing:
plumbing data related to plumbing connecting the fluid sections, and wiring data related to wiring electrically connecting the devices; and/or
a series of plumbing data sets comprising a plurality of continuously linked plumbing data, and a series of wiring data sets comprising a plurality of continuously linked wiring data;
a display for displaying the plumbing data and wiring data stored in the memory, and/or the series of plumbing data sets and series of wiring data sets stored in the memory; and
a display switcher for switching, in accordance with a reception of an instruction signal generated by an operation of a pointing device, a display format of the plumbing data or wiring data corresponding to the instruction signal, or a series of plumbing data sets or series of wiring data sets corresponding to the instruction signal to another display format.

10. The maintenance computer according to claim 9, wherein the memory comprises:
a plumbing/wiring data storage section for storing the plumbing data and wiring data; and
a data set storage section for storing the series of plumbing data sets and series of wiring data sets associated with position information of the plumbing data or wiring data;
wherein, the display displays the plumbing data and the wiring data stored in the memory;
and wherein, the display switcher switches the display format of the series of plumbing data sets or series of wiring data sets, in which the plumbing data or wiring data corresponding to the instruction signal is contained, to another display format.

11. The maintenance computer according to claim 9 further comprising a determiner for determining whether a position specified by an operation of the pointing device is within a predetermined range of a display position of the plumbing data or wiring data;
and wherein the display switcher switches the display format when it is determined by the determiner that the position is within the predetermined range.

12. The maintenance computer according to claim 11 further comprising:
a selection receiver for receiving a selection of a series of plumbing data sets or series of wiring data sets comprising plumbing data or wiring data corresponding to the specified position when the determiner determines the specified position is within the predetermined range; and
a display format setter for setting the display format of the selected series of plumbing data sets or series of wiring data sets, when a selection is received by the selection receiver, to the display format of the moment the selection is received.

13. The maintenance computer according to claim 12 further comprising a detail information display for displaying detail information related to a connection of a terminus of the selected series of plumbing data sets or series of wiring data sets when a selection is received by the selection receiver.

14. The maintenance computer according to claim 13, wherein the detail information display displays an image representing a state of the connection of the terminus of the series of plumbing data sets or series of wiring data sets for which the selection is received by the selection receiver.

15. The maintenance computer according to claim 13 further comprising a window switcher,
wherein, the display displays the stored plumbing data or wiring data in one window,
the detail information display displays, in another window, an image representing the state of the connection of the terminus of the selected series of plumbing data sets or series of wiring data sets;
and wherein the window switcher switches the display content of the one window and the other window.

16. The maintenance computer according to claim 9, wherein
the display switcher switches a display color of the plumbing data or wiring data, or the series of plumbing data sets or series of wiring data sets to another display color.

17. A computer program product for a maintenance computer used for a maintenance operation of a sample processing apparatus comprising a plurality of fluid sections for processing a sample, and plurality of devices for controlling a flow of a sample by the fluid sections;
a computer readable medium for storing:
plumbing data related to plumbing for connecting the fluid sections, wiring data related to the wiring electrically connecting the devices, and/or a series of plumbing data sets comprising a plurality of continuously linked plumbing data and a series of wiring data sets comprising a plurality of continuously linked wiring data; and
instructions adapted to enable a general purpose computer to carry out operations, comprising:
displaying the plumbing data and wiring data, and/or the series of plumbing data sets and series of wiring data sets; and
switching, in accordance with a reception of an instruction signal generated by an operation of a pointing device, a display format of the plumbing data or wiring data corresponding to a received instruction signal, or a series of plumbing data sets or series of wiring data sets corresponding to the instruction data to another display format.

18. The computer program product according to claim 17, wherein
the plumbing data and wiring data, and the series of plumbing data sets and series of wiring data sets are associated with position information of the plumbing data or wiring data;
the displaying operation comprises displaying the plumbing data and the wiring data;
and wherein the switching operation comprises switching, to another display format, the display format of the series of plumbing data sets or series of wiring data sets containing the plumbing data or wiring data corresponding to the instruction signal.

19. The maintenance computer according to claim 17, wherein the operations further comprise determining whether a position specified by the pointing device is positioned within a predetermined range of a display position of the plumbing data or wiring data;
and wherein the switching operation is executed when it is determined by the determining operation that the specified position is within the predetermined range.

20. The maintenance computer according to claim 19, wherein the operations further comprise:
receiving a selection of a series of plumbing data sets or series of wiring data sets containing plumbing data or wiring data corresponding to the specified position when it is determined by the determining operation that the specified position is within the predetermined range; and
setting the display format of the selected series of plumbing data sets or series of wiring data sets, when a selection is received, to the display format of the moment the selection is received.
